(19) United States
(12) Patent Application Publication
(10) Pub. No.: US 2026/0142930 A1
(43) Pub. Date: May 21, 2026

(54) HANDLING TRANSMISSION OF PACKETS IN TSN SYSTEM

(71) Applicant: Telefonaktiebolaget LM Ericsson (publ), Stockholm (SE)

(72) Inventors: Dhruvin PATEL, AACHEN (DE); Joachim SACHS, SOLLENTUNA (SE); János FARKAS, KECSKEMÉT (HU); János HARMATOS, Budapest (HU); Balázs VARGA, BUDAPEST (HU); Marilet De Andrade JARDIM, KISTA (SE); György MIKLÓS, PILISBOROSJENÖ (HU)

(73) Assignee: Telefonaktiebolaget LM Ericsson (publ), Stockholm (SE)

(21) Appl. No.: 19/119,411

(22) PCT Filed: Nov. 7, 2022
(86) PCT No.: PCT/SE2022/051025

§ 371 Date: Apr. 9, 2025

(51) Int. Cl. H04L 47/62

(52) U.S. Cl. CPC H04L 47/624; H04L 47/6215

(57) ABSTRACT

Embodiments of the present disclosure provide a method performed by a network node of a wireless communication network. The wireless communication network operates as a virtual Time-Sensitive Networking, TSN, bridge of a TSN system. The method includes obtaining information identifying a number of retransmissions to be performed for delivery of one or more packets from the network node to a TSN node. The method includes selecting a queue for each packet, from a set of available queues at the network node based on the information identifying the number of retransmissions. The method includes transmitting the one or more packets from the set of available queues according to a predetermined scheme.

### TECHNICAL FIELD

The present disclosure relates generally to the field of Time Sensitive Networking, TSN, systems. More particularly, it relates to method, network node, and computer program products for transmission of one or more packets in a TSN system based on retransmission information to reduce Packet Delay Variation, PDV.

### BACKGROUND

An automation industry is undergoing a digital transformation towards the “Fourth Industrial Revolution” (Industry 4.0), which involves smart manufacturing. Flexible connectivity infrastructure provided by the automation industry is a key enabler for manufacturing to interconnect machines, products and all kinds of other devices in a flexible, secure, and consistent manner.

Communication technology enablers for the digital transformation of the automation industry are Time Sensitive Networking, TSN, system (TSN network) on a wireline side, and a Third Generation Partnership Project, 3GPP, Fifth Generation, 5G, network on a wireless side. The TSN system is based on the Institute of Electrical and Electronics Engineers, IEEE 802.3 Ethernet standard. The TSN system provides deterministic services through IEEE 802.3 networks, for example, time synchronization, guaranteed low latency transmissions and high reliability. The 5G network, an alternative to a wired connectivity solution supports communication with unprecedented reliability and very low latency, as well as massive Internet of Things, IoT, connectivity. Thus, the TSN system and the 5G network are considered as complementary technologies in providing deterministic communication services, thereby paying the way towards future advanced manufacturing systems and other vertical areas. Also, the TSN system and the 5G network are essential for network convergence that is a support of all kinds of communication services via a same network infrastructure. Therefore, the TSN system can be integrated to the 5G network, which supports the deterministic communication services over heterogeneous infrastructure and multiple application domains required for the network convergence. The integration of the TSN system to the 5G system provides converged communication on the same network infrastructure for a wide range of services, for example, time sensitive applications that require deterministic, reliable and low latency communications.

With the integration of the TSN system to the 5G network, the 5G network is deployed as a set of IEEE compliant virtual TSN nodes (also be referred to as virtual TSN bridges). The virtual-TSN node can be connected to TSN nodes (also be referred to wired TSN nodes/bridges). The 5G network comprises a 5G core network and a Radio Access Network, RAN. A User Plane Function, UPF, of the 5G core network acts as a gateway to the TSN system. The RAN spans over a production plant to provide wireless connectivity to one or more User Equipments, UEs.

The 5G network/virtual TSN node defines several gateways between the TSN system and the 5G network. The gateways include a TSN Application Function, AF, device side TSN translators, DS-TTs on the UEs, and network side TSN translators, NW-TT on the UPF. The TSN AF connects a Centralized Network Controller, CNC, a Centralized User Configuration, CUC and a 5G control plane.

End-to-end, E2E, time sensitive/deterministic communication provided by the integrated TSN-5G system requires deterministic transmission latency between an ingress port and an egress port. The deterministic transmission latency may be described as an upper bound/maximum allowed packet delay, PD_max, together with a maximum tolerated Packet Delay Variation, PDV. An Ethernet based TSN system can provide a small PDV due to wired connectivity characteristics. A minimum and maximum delay between port pairs of the TSN node are key characteristics for computations to achieve the deterministic transmission latency. However, there are some substantial differences between the 5G network/virtual TSN node and the TSN nodes of the TSN system. One of the differences is that PDV of the 5G network remains considerable higher, for example, 1-2 orders of magnitude compared to the wired TSN nodes where latencies can be controlled at a level of 10's microsecond. Thus, a key challenge in achieving the deterministic transmission latency in the integrated TSN-5G network is higher PDV of the 5G network. In addition, the higher PDV of the 5G network makes it difficult to practically apply time scheduled transmission for time schedule configurations, even though a support for 802.1Qbv has been targeted in the 5G standard via a hold and forward mechanism.

### SUMMARY

It is desirable to limit the PDV of the virtual TSN node/5G network to a similar level as determined in the TSN nodes to ensure integration and interworking of the TSN system with the wireless communication network/5G network.

Consequently, there is a need for an improved method and arrangement for transmission of one or more packets based on information related to a number of RAN retransmissions to be performed for delivering of the one or more packets from a network node, which reduces the PDV that alleviates at least some of the above-cited problems.

It is therefore an object of the present disclosure to provide a method, a network node, and a computer program product for transmission of the one or more packets based on the information related to the number of RAN retransmissions to be performed for delivering of the one or more packets from the network node, to mitigate, alleviate, or eliminate all or at least some of the above-discussed drawbacks of presently known solutions.

This and other objects are achieved by means of a method, a network node, and a computer program product as defined in the appended claims. The term exemplary is in the present context to be understood as serving as an instance, example or illustration.

According to a first aspect of the present disclose, a method performed by a network node of a wireless communication network is provided. The wireless communication network operates as a virtual Time-Sensitive Networking, TSN, bridge of a TSN system. The method comprises obtaining information identifying a number of RAN retransmissions to be performed for delivery of one or more packets from the network node to a TSN node. The method comprises selecting a queue for each packet, from a set of available queues, at the network node based on the information identifying the number of retransmissions. The method comprises transmitting the one or more packets from the set of available queues according to a predetermined scheme.

In some embodiments, the step of obtaining the information related to the number of retransmissions to be performed for delivery of the one or more packets comprises estimating the number of retransmissions to be performed for delivery of the one or more packets based on one or more of: information received from a scheduler of the network node, a number of retransmissions performed by a transmitter of the network node, and a number of retransmissions required to be performed for decoding the packet at a receiver of the network node.

In some embodiments, the step of selecting the queue for each packet, from the set of available queues at the network node based on the information related to the number of retransmissions comprises determining a number of available queues at the network node and a queue that is currently being served for transmission of packets from the network node. The method comprises selecting the queue for transmitting each packet based on the number of available queues, the queue currently being served and the number of retransmissions associated with each packet.

In some embodiments, the step of transmitting the one or more packets from the selected queue comprises selecting the queue for transmission of the one or more packets from the set of available queues at the network node in a cyclic order, and transmitting each packet from the selected queue, wherein each packet is allowed to be stored in a selected queue for a pre-determined time interval.

According to a second aspect of the present disclosure, an apparatus of a network node of a wireless communication network is provided. The wireless communication network operates as a virtual Time-Sensitive Networking, TSN, bridge of a TSN system. The apparatus is configured to cause obtaining of information identifying a number of retransmissions to be performed for delivery of one or more packets from the network node to a TSN node. The apparatus is configured to cause selection of a queue for each packet, from a set of available queues at the network node based on the information identifying the number of retransmissions. The apparatus is configured to cause transmission of the one or more packets from the set of available queues according to a predetermined scheme.

A third aspect is a network node comprising the apparatus of the second aspect.

According to a fourth aspect of the present disclosure, there is provided a computer program product comprising a non-transitory computer readable medium, having thereon a computer program comprising program instructions. The computer program is loadable into a data processing unit and configured to cause execution of the method according to the first aspect when the computer program is run by the data processing unit.

In some embodiments, any of the above aspects may additionally have features identical with or corresponding to any of the various features as explained above for any of the other aspects.

An advantage of some embodiments is that alternative and/or improved approaches are provided for handling transmission of the one or more packets for reducing packet delay variation, PDV, in the TSN system integrated to the wireless communication system operating as the virtual TSN bridge/node.

An advantage of some embodiments is that the queue from the set of available queues at the network node is selected for each packet based on the information related to the number of retransmissions and the one or more packets are transmitted from the set of available queues according to the cyclic order. Thereby, providing a packet delay correction, PDC, mechanism for decreasing or correcting the PDV.

An advantage of some embodiments is that the PDC mechanism enables bounding down of not only an upper bound of packet delay but also the PDV of the transmission to microsecond range.

An advantage of some embodiments is that the PDC mechanism controls a lower bound of packet delay to become tighter towards the upper bound of packet delay, so that maximum PDV is controlled.

An advantage of some embodiments is that a combination of Ultra-Reliable Low Latency Communications, URLLC, provided by the wireless communication network and the PDC mechanism aid in achieving deterministic transmission with the PDV around a configured target latency.

Other advantages may be readily apparent to one having skill in the art. Certain embodiments may have none, some, or all of the recited advantages.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 discloses an example of a Time Sensitive Networking, TSN, system integrated to a wireless communication network according to some examples;

FIG. 2 discloses an example of a TSN system integrated to a wireless communication network, which acts as a virtual TSN node according to some examples;

FIG. 3 discloses an example of a wireless communication network according to some examples;

FIG. 4 discloses an example architecture of a TSN system integrated to a wireless communication network according to some examples;

FIG. 5 is a flowchart illustrating example method steps according to some examples;

FIGS. 6A and 6B disclose example illustrations of a packet delay correction, PDC, mechanism according to some examples;

FIGS. 7A and 7B disclose example illustrations of a PDC mechanism based on information related to number of retransmissions of packets according to some examples;

FIG. 8 discloses an example illustration of a PDC mechanism based on selection of a queue from a set of available queues at a network node according to some examples;

FIG. 9 is a schematic block diagram illustrating an example apparatus according to some embodiments; and

FIG. 10 discloses an example computing environment according to some examples.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the invention. It should be emphasized that the term “comprises/comprising” when used in this specification is taken to specify the presence of stated features, integers, steps, or components, but does not preclude the presence or addition of one or more other features, integers, steps, components, or groups thereof. As used herein, the singular forms “a”, “an” and “the” are intended to include the plural forms as well, unless the context clearly indicates otherwise.

Network node: As used herein, a network node (also be referred to as radio access node, radio network node, or the like) is any node in a Radio Access Network, RAN, of a wireless communication network that operates to wirelessly transmit and/or receive signals. Some examples of the network node include, but are not limited to, a base station (for example a New Radio, NR, base station, gNB, in a Third Generation Partnership Project, 3GPP, Fifth Generation, 5G, NR network or an enhanced or evolved Node B, eNB, in a 3GPP Long Term Evolution, LTE, network), a high-power or macro base station, a low-power base station (for example, a micro base station, a pico base station, a home eNB, or the like), a relay node, and so on.

Core network node: As used herein, a core network node is any type of node in a core network that implements a core network function. Some examples of the core network node include, for example, a Mobility Management Entity, MME, a Packet Data Network Gateway, P-GW, a Service Capability Exposure Function, SCEF, a Home Subscriber Server, HSS, or the like. Some other examples of the core network node include a node implementing an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on.

User Equipment, UE: As used herein, a UE (also be referred to as wireless device) is any type of device that has access to (i.e., is served by) a wireless communication network by wirelessly transmitting and/or receiving signals to a network node(s). Some examples of the UE are a target device, a device to device, D2D, UE, a machine type UE, a UE capable of machine to machine, M2M, communication, personal digital assistant, PDA, tablet, mobile terminals, smart phone, laptop embedded equipped, LEE, laptop mounted equipment, LME, universal serial bus, USB, dongles, UE category M2, ProSe UE, and so on.

Note that the description given herein focuses on a 3GPP wireless communication network and, as such, 3GPP terminology or terminology similar to 3GPP terminology is oftentimes used. However, the concepts disclosed herein are not limited to a 3GPP system.

Embodiments of the present disclosure will be described and exemplified more fully hereinafter with reference to the accompanying drawings. The solutions disclosed herein can, however, be realized in many different forms and should not be construed as being limited to the examples set forth herein.

It will be appreciated that when the present disclosure is described in terms of a method, it may also be embodied in one or more processors and one or more memories coupled to the one or more processors, wherein the one or more memories store one or more programs that perform the steps, services and functions disclosed herein when executed by the one or more processors.

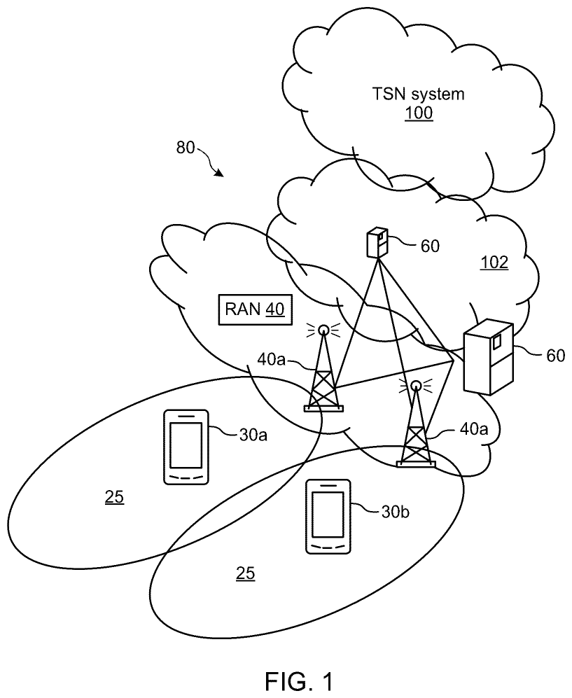

FIG. 1 discloses an example of a Time Sensitive Networking, TSN, system, 100 integrated to a wireless communication network 80. As depicted in FIG. 1, the TSN system 100 is integrated to the wireless communication network 80 to provide converged communication on a same network infrastructure for a wide range of services, for example, time sensitive applications that require deterministic, reliable and low latency communications.

The TSN system (also be referred to as TSN network) 100 may be based on the Institute of Electrical and Electronics Engineers, IEEE 802.3 Ethernet standard. The TSN system may provide deterministic services through IEEE 802.3 networks, for example, time synchronization, guaranteed low latency transmissions and high reliability.

The wireless communication network (also be referred to wireless communication system, cellular communication network/system, or the like) may be a wireless network, for example, a Fifth Generation, 5GS, network, a Long Term Evolution, LTE, network, an Evolved Universal Terrestrial Radio Access Network, E-UTRAN, a Wideband Code Division Multiple Access, WCDMA, network, a Global System for Mobile communications, GSM, network, a Worldwide Interoperability for Microwave Access, WiMAX, or any other future generation network.

The wireless communication network 80 comprises a Radio Access Network, RAN, 40 and a core network, CN, 60. The wireless communication network 100 may use a number of different Radio Access Technologies, RATs, such as LTE, LTE-Advanced, 5G, WCDMA, GSM/Enhanced Data rate for GSM Evolution, EDGE, WiMAX, Ultra Mobile Broadband, WMB, or the like.

The RAN 40 comprises one or more network nodes 40a, each providing radio coverage over one or more geographical areas, such as cells 25 supporting the one or more RATs. In some examples, the network node 40a may be a radio access node such as a radio network controller, an access point such as a Wireless Local Area Network, WLAN, access point or an Access Point Station, AP STA, an access controller, a base station, a base transceiver station, an Access Point base station, a base station router, a transmission arrangement of a radio base station, a standalone access point, or any other unit of the RAN capable of serving one or more User Equipments, UEs 30a, 30b, in the cell/service area. Examples of the base station may include, a gNodeB, gNB, an evolved Node B, eNB, and so on.

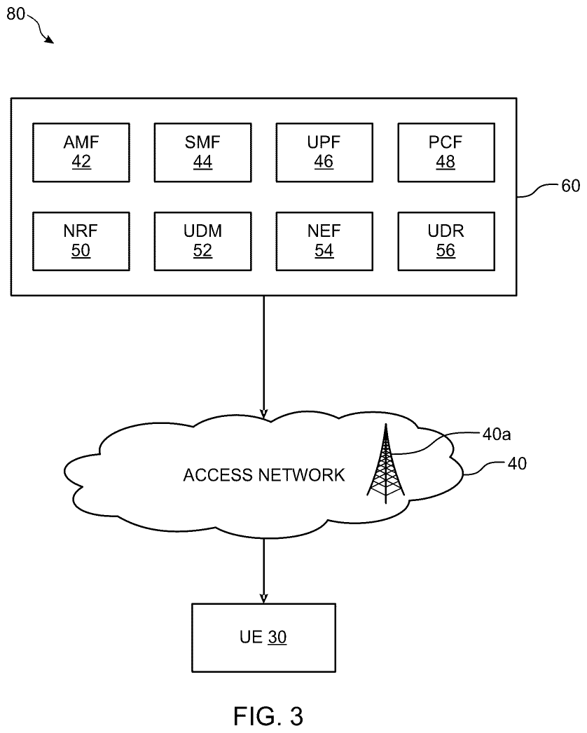

The CN 60 comprises a core network node. The core network node may be configured to communicate with the network node 40a via an interface, for example, an S1 interface. Examples of the core network node may include, a Mobile Switching Centre, MSC, a Mobility Management Entity, MME, an Operation and Management, O&M, node, an Operation, Administration and Maintenance, OAM, node, an Operations Support Systems, OSS, node, a Self-Organizing Network, SON, node, a Packet Data Network Gateway, P-GW, a Service Capability Exposure Function, SCEF, a Home Subscriber Server, HSS, or the like. The core network node may further be a distributed node comprised in a cloud 102. The core network node may further include a node implementing network functions of the CN 60 such as but are not limited to, an Access and Mobility Function, AMF, a User Plane Function, UPF, a Session Management Function, SMF, an Authentication Server Function, AUSF, a Network Slice Selection Function, NSSF, a Network Exposure Function, NEF, a Network Repository Function, NRF, a Policy Control Function, PCF, a Unified Data Management, UDM, and so on. The network functions of the CN 60 are described in detail in conjunction with FIG. 3.

In the wireless communication network 80, the one or more UEs 30a and 30b (collectively referred to as UE 30) may communicate with the CN 60 via the network nodes 40a of the RAN 40. Examples of the UE 30 may include, a wireless device, a mobile station, a non-access point, non-AP, station, STA, a wireless terminal, or the like. It should be understood by those skilled in the art that “wireless device” is a non-limiting term, which means any terminal, a wireless communication terminal, a User Equipment, a Mobile Type Communication, MTC, device, a Device to Device, D2D, terminal, or a node for example, a smart phone, a laptop, a mobile phone, a sensor, a relay, a mobile tablet, or even a base station communicating within the cell.

The UE 30 may be located in the cell 25 of the network node 40a, which is referred to as a serving cell and the cell of other network nodes may be referred to as neighbouring cells for the UE 30. Although the network node 40a, in FIG. 1, is only providing a serving cell 25, the network node 40a may further provide one or more neighbouring cells to the serving cell 25.

The UE 30 (also be referred to as first end station) may be connected to one or more end stations such as one or more second end stations. The second end station may include, but are not limited to, robots, a factory floor, or the like.

The wireless communication network 80 may according to some embodiments herein communicate with one or more nodes in the TSN system 100. The TSN system 100 may be connected to one or more end stations, such as, the second end stations.

According to some embodiments herein, with the integration of the TSN system 100, the wireless communication network 80 operates as a TSN virtual node (also be referred to as TSN virtual bridge, virtual wireless bridge, or the like).

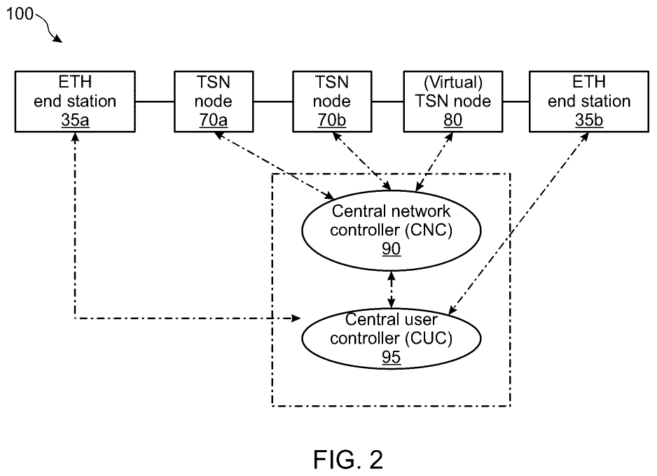

FIG. 2 discloses an example of the TSN system 100 integrated to the wireless communication network 80, wherein the wireless communication network 80 operates as the virtual TSN node. The TSN system 100 comprises one or more TSN nodes. For simplicity, the TSN system 100 comprising TSN nodes 70a and 70b is depicted in FIG. 2. The TSN nodes 70a and 70b may be wired TSN nodes (also be referred to as wired nodes, wired TSN bridges, or the like). With the integration of the TSN system 100 to the wireless communication network 80, the TSN system 100 may comprise the virtual TSN node/bridge 80. The virtual TSN node 80 referred herein may be the wireless communication network 80 or the virtual TSN node 80 may be a node implemented by the wireless communication network 80.

The TSN nodes 70a and 70b, and the virtual TSN node 80 may be connected to one or more end stations, for example, second end stations, which suppose to exchange time sensitive communication. The time sensitive communication may comprise TSN streams or TSN packets, or TSN flows to be exchanged between the end stations. As depicted in FIG. 2, the TSN node 70a may be connected to an end station 35a and the virtual TSN node 80 may be connected to an end station 35b. Examples of the end stations 35a and 35b may include, but are not limited to, robots, a factory floor, or the like. The end stations 35a and 35b may be connected to the UEs associated with the virtual TSN node 80 through the TSN nodes 70a/70b (not shown).

In some examples, the TSN nodes 70a and 70b, the virtual TSN node 80, and the end stations 35a and 35b may be configured in a static configuration setup or a centralized network configuration setup. In the static configuration setup, the TSN nodes 70a and 70b, the virtual TSN node 80, and the end stations 35a and 35b may be configured during network setup. In the centralized network configuration setup, a Centralized Network Controller, CNC, 90 (also be referred to as centralized network configuration, TSN controller, or the like) may configure the TSN nodes 70a and 70b, and the virtual TSN node 80 for TSN streams (data packets exchanged between the end stations through the TSN nodes 70a and 70b and the virtual TSN node 80). The CNC 90 may be adapted for configuring network resource reservations for the TSN nodes 70a and 70b, and the virtual TSN node 80. The CNC 90 may also be adapted for coordinating any changes to the configured network resource reservations with any new reservations. The network resource reservations may be made or requested by the end stations 35a and 35b. In the fully centralized network configuration setup where both network and user configuration are centralized, the CNC may receive requirements of data flows from a Centralized User Controller, CUC, 95 (also be referred to as centralized user configuration) and then compute a route, and a time schedule required for end-to-end, E2E, transmission for each TSN stream. The CNC may also configure the TSN nodes 70a and 70b and the virtual TSN node 80 in accordance with the computed route and time schedule.

In some embodiments, the wireless communication network acting as the virtual TSN node 80 may obtain, from a controller of the TSN system (not shown) or the CNC 90, one or more TSN Quality of Service, Qos, parameters and information related to a traffic pattern for the virtual TSN node 80. The TSN QoS parameters may be mapped to QoS policy(ies) and/or rules in the wireless communication network and applied in the wireless communication network in order to satisfy TSN QoS requirements for the virtual TSN node. In addition, at least some of the information related to the traffic pattern for the virtual TSN node may be provided to an edge node to achieve the desired traffic pattern. In some examples, the edge node may be the UPF of the CN for uplink direction or the UE for downlink direction.

In some other embodiments, the wireless communication system operating as the virtual TSN node 80 may obtain, from the controller of the TSN system or the CNC 90, information related to the traffic pattern for the preceding TSN node 70b (the TSN node that precedes the virtual TSN node 80 in a direction of TSN traffic flow). At least some of the information related to the traffic pattern for the preceding TSN node 70b may be provided to the one or more network nodes of the wireless communication system for radio optimization. Components of the wireless communication network operating as the virtual TSN node 80 is described in detail in conjunction with FIG. 3.

FIG. 3 discloses the wireless communication network 80 operating as the virtual TSN node, while integrated to the TSN system. As depicted in FIG. 3, the wireless communication network 80 comprises the RAN 40, the CN 60, and the UE 30. The RAN 40 includes the network node 40a.

The network node 40a may be directly connected to the UE 30. The network node 40a may include a group of a plurality of base stations including a base station, and the plurality of base stations may perform communication via an interface. The base station may have a structure having a central unit, CU, and a distributed unit, DU, separated from each other. In this case, one CU may control a plurality of DUs. The base station may be referred to as an access point, AP, a next-generation node i.e., a gNB, a 5th generation node, a wireless point, or a transmission/reception point, TRP, or the like. The UE 30 accesses the RAN 40 and communicates with the network node 40a through a wireless channel. The UE 30 may be a user equipment, UE, a mobile station, a subscriber station, a remote terminal, a wireless terminal or the like.

The CN 60, which is the network that manages or controls the RAN 40 and processes data and control signals for the UE 30, transmitted and received via the RAN 40. The CN 60 may perform various functions including control of a user plane and a control plane, processing of mobility, management of subscriber information, charging, and interworking with other types of systems such as, LTE, system.

To perform the various functions described above, the CN 60 may include a plurality of functionally separated entities (i.e., core network nodes) having different network functions. For example, the network functions may include an AMF 42, a SMF 44, a UPF 46, a PCF 48, a network repository function, NRF 50, a UDM 52, a NEF 54, and a unified data repository UDR 55. Although, not shown in FIG. 3, the CN 60 may interwork with a TSN Application Function, AF, the CNC and the TSN system. In some examples, the CN 60 may be referred as a 5th generation, 5G, core, 5GC, which is a core network of a 5G system.

The UE 30 connected to the RAN 40 may accesses the AMF 42, which performs a mobility management function of the CN 60. The AMF 42 is a function or a device that is responsible for both access to the RAN 40 and the mobility management of the UE 30. The SMF 44 is a network function that manages a session. The AMF 42 may be connected to the SMF 44, and the AMF 42 may route session-related messages of the UE 30 to the SMF 44. The SMF 44 may be connected to the UPF 46 to allocate a user plane resource to be provided to the UE 30 and establish a tunnel for transmitting data between the network node 40a and the UPF 46. The SMF 44, as a main entity managing a Protocol Data Unit, PDU session, may be responsible for QoS setting/update for QoS flows in the PDU session. The PCF 48 may control information associated with a policy and charging of a session used by the UE 30. The NRF 50 may be connected to all the network functions. Each network function is registered with the NRF 50 when starting to run in the operator network, so as to inform the NRF 50 that the network function is running in the wireless communication network 80. The UDM 52, as a network function may perform a role similar to a home subscriber server, HSS, of a 4G network, and store subscription information of the UE 30 or context information used by the UE 30 in the network.

The NEF 54 may serve to connect a third party server to the network function in the wireless communication network 80. In addition, the NEF 54 may serve to provide data to the UDR 56 and to update or obtain data. The UDR 56 may serve to store subscription information of the UE 30, store policy information, store data exposed to the outside, or store information necessary for a third-party application. Further, the UDR 56 may also serve to provide stored data to other network functions.

The UDM 52, PCF 48, SMF 44, AMF 42, NRF 50, NEF 54, and UDR 56 may be connected to a service-based interface. Services or application programing interfaces, APIs, provided by these network functions are used by other network functions and thus may exchange control messages with each other. For example, when the AMF 42 delivers a session-related message to the SMF 44, a service or API called Nsmf_PDUSession_CreateSMContext may be used.

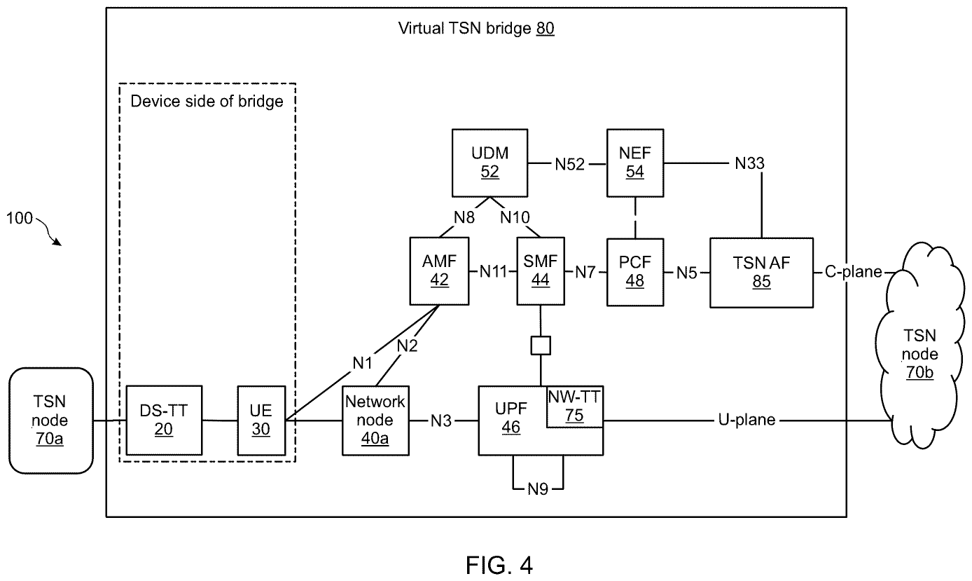

FIG. 4 discloses an example architecture of the TSN system 100 integrated with the wireless communication network 80 in which embodiments of the present disclosure may be implemented. For a seamless integration between the wireless communication network 80 and the TSN system 100, the wireless communication network 80 and the TSN system 100 may interoperate in a transparent manner to minimize impact on other TSN entities.

With the integration of the TSN system 100 to the wireless communication network 80, the TSN system 100 comprises the one or more TSN nodes/wired TSN bridges 70a and 70b, and the virtual TSN node/virtual TSN bridge 80. The TSN nodes 70a and 70b and the virtual TSN bridge/node 80 are described in detail in conjunction with FIG. 2.

The virtual TSN node/wireless communication network 80 comprises the RAN and the CN. The RAN comprises the network node 40a. The CN comprises network functions such as, the AMF 42, the SMF 44, the PCF 48, the NEF 54, the UDM 52, the UPF 46, or the like. All these network functions of the CN are described in detail in conjunction with FIG. 3.

In some examples, the virtual TSN node/wireless communication network 80 may define several gateways, which enable the virtual TSN node 80 to communicate with the TSN system 100 and the CNC. The gateways may include the TSN AF, a device side TSN translator, DS-TT, 20, on the UE 30, and a network side TSN translator, NW-TT, 75 on the UPF 46 of the CN. TSN ingress ports and egress ports may be provided via the DS-TT 20 on the UE 30 and via the NW-TT 75 on the CN.

The TSN AF 85 may be configured to connect the CNC and CUC entities and a control plane, C-plane. In some examples, the TSN AF 85 may be associated with the CN. In some examples, the TSN AF 85 may be a third party entity outside an operator network or an entity inside the operator network. For example, the TSN AF 85 may be an entity within the CN, which is inside the operator network, since the CN corresponds to an essential function for supporting TSN. The TSN AF 85 may derive information about a TSN stream from information provided by the CNC 90 in the form of bridge management information, and possibly using other configuration data. The TSN AF 85 may determine QoS parameters including: a priority, a Maximum Burst Size, a delay and a Maximum Bitrate, and may provide these parameters to the PCF 48.

Further, the CNC may be adapted to configure and operate the TSN nodes 70a and 70b of the TSN system 100 and the virtual TSN node 80. Configuring, by the CNC, the TSN nodes 70a and 70b of the TSN system 100 and the virtual TSN node 80 are described in detail in FIG. 2.

The CNC operates the virtual TSN node 80 by considering the virtual TSN node 80 as the TSN node. However, there are some substantial differences between the virtual TSN node 80 and the TSN node 70a/70b. One of the differences may be in achieving deterministic transmission latency due to Packet Delay Variation, PDV. The PDV of the wireless communication network 80 may remain considerably higher and for example, may be in 1-2 orders of magnitude, compared to the TSN nodes 70a, and 70b of the TSN system 100, wherein latencies may be controlled at the level of 10's microseconds. Such a high PDV of the wireless communication network 80 makes it difficult to practically apply time-scheduled transmission for time-schedule configurations. However, it is desirable to limit the PDV of the virtual TSN node 80 to a similar level as determined in the TSN nodes 70a and 70b to ensure integration and interworking of the TSN system with the wireless communication network 80.

Therefore, according to some embodiments of the present disclosure, the network node 40a in the wireless communication network/virtual TSN node 80, implements a method for handling transmission of one or more packets from the network node 40a to the TSN node 70a/70b for reducing the PDV.

The network node 40a obtains information identifying a number of retransmissions to be performed for delivery of one or more packets from the network node 40a to the TSN node 70a/70b. In some examples, the packets may comprise data packets to be exchanged between the network node 40a and the TSN node 70a/70b, wherein said data packets may intended to the end stations. The network node 40a selects a queue for a packet, from a set of available queues at the network node 40a based on the information identifying the number of retransmissions. The network node 40a transmits the one or more packets from the set of available queues according to a predetermined scheme. In some examples, the predetermined scheme may correspond to a cyclic order to be followed for transmitting the one or more packets from the set of available queues. Thus, proper selection of the queues from the set of available queues for each packet and transmission of the packets from the set of available queues in the cyclic order may increase a lower bound of packet delay towards an upper bound of the packet delay, which results in a narrower time window for a guaranteed packet delivery. As a result, the PDV may be decreased/corrected.

Various examples for handling transmission of one or more packets from the network node 40a to the TSN node 70a/70b for reducing the PDV are explained in conjunction with figures in the later parts of the description.

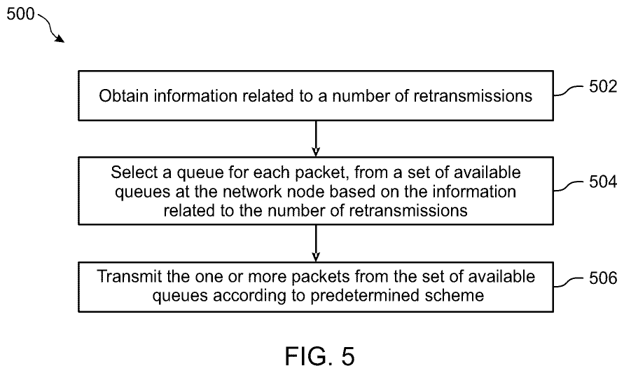

FIG. 5 is a flowchart illustrating example method steps of a method 500 performed by the network node in the wireless communication network for transmission of one or more packets. The wireless communication network operates as the virtual TSN bridge/node of the TSN system, wherein the virtual TSN node being connected to the plurality of TSN nodes of the TSN system.

At step 502, the method 500 comprises obtaining information identifying a number of retransmissions to be performed for delivery of one or more packets from the network node to the TSN node. In some examples, the one or more packets may refer to data packets supposed to be exchanged between the network node and the TSN node. The data packets may be intended for the end stations connected to the UE, which is further connected to the network node. In some examples, the network node may deliver the one or more packets to the TSN node through a hierarchy of layers such as a Service Data Unit (a higher layer), and a Protocol Data Unit (a lower layer)

In some embodiments, the step 502 of obtaining the information identifying the number of retransmissions to be performed for delivery of the one or more packets may comprise estimating the number of retransmissions to be performed for delivery of the one or more packets based on one or more of: information received from a scheduler of the network node, a number of retransmissions performed by a transmitter of the network node, and a number of transmissions required to be performed for decoding the packet at a receiver of the network node. In some examples, the number of retransmissions required to be performed for decoding the packet at the receiver of the network node may be determined in accordance with a Hybrid automatic repeat request, HARQ, process.

In some examples, in case of segmentation of the SDU into PDUs, the information identifying the number of retransmissions to be performed may indicate a retransmission count for the PDU with the highest number of retransmissions used for the SDU. Optionally, the PDU may also follow transmission, Tx, queueing, for example, due to segmentation.

Based on the information identifying the number of retransmissions, at step 504, the method 500 comprises selecting a queue for each packet, from a set of available queues at the network node. In some examples, the set of queues may be maintained at the SDU level of a receiver side (for example, in Packet Data Convergence Protocol, PDCP/Service Data Adaptation Protocol, SDAP) in the network node.

In some embodiments, the step 504 of selecting the queue for each packet, from the set of available queues at the network node may comprise determining a number of available queues at the network node and a queue that is currently being served for transmission of packets from the network node. Based on the number of available queues, the queue currently being served and the number of retransmissions associated with each packet, the method may comprise selecting the queue for transmitting each packet.

Upon selecting the queue for each packet, at step 506, the method 500 comprises transmitting the one or more packets from the set of available queues according to a predetermined scheme.

In some embodiments, the step 506 of transmitting the one or more packets from the selected queue may comprise selecting the queue for transmission of the one or more packets from the set of available queues at the network node in a cyclic order and transmitting each packet from the selected queue. Each packet is allowed to be stored in a selected queue for a pre-determined time interval. Such a transmission may increase a lower bound of packet delay towards an upper bound, which reduces PDV by bounding down PDV to a level of microseconds or 10's of microseconds with high probabilities.

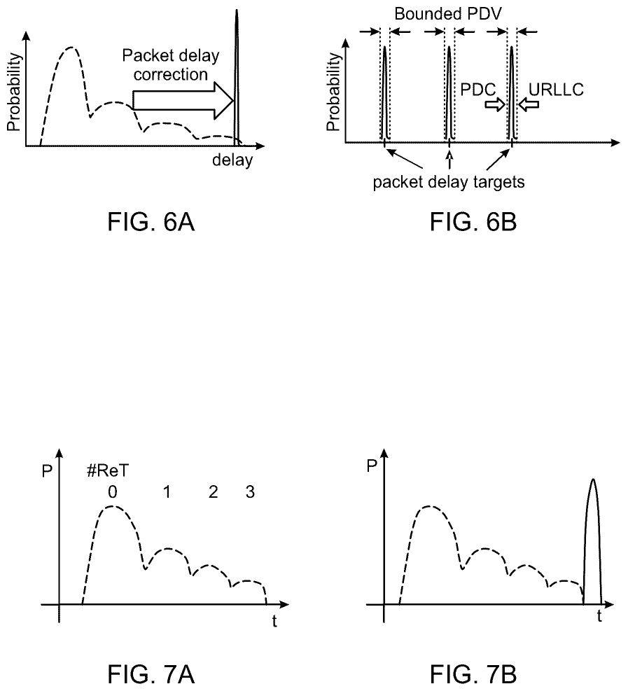

FIGS. 6A and 6B disclose example illustrations of a packet delay correction, PDC, mechanism. In embodiments disclosed herein, the PDC mechanism may refer to steps of selecting the queue for each packet, from the set of available queues at the network node based on the information identifying the number of retransmissions to be performed for delivery of one or more packets from the network node to the TSN node and transmitting the one or more packets from the set of available queues in accordance with the predetermined scheme/cyclic order. The PDC mechanism may be implemented by the network node to reduce variation in packet delay that is PDV. The packet delay may occur in the wireless communication network while transferring the one or more packets from the TSN ingress node/TSN ingress port (i.e., the DS-TT) to the UE over an air interface.

A probability of delivering a packet within a time window described by a lower bound and an upper bound of the packet delay is depicted in FIG. 6A. The network node may implement the PDC mechanism to increase the lower bound of the packet delay towards the upper bound of the packet delay, so that a narrower time window may be obtained for a guaranteed delivery of the packet. The increased lower bound towards the upper bound corrects the packet delay, which results in bounded PDV.

The bounded PDV achieved by the PDC mechanism is depicted in FIG. 6B. The bounded PDV may provide a bounded packet delay target, which is towards the upper bound of the packet delay.

FIGS. 7A and 7B disclose another example illustrations of the PDC mechanism based on information identifying the number of retransmissions of packets. In embodiments disclosed herein, the PDC mechanism may refer to steps of selecting the queue for each packet, from the set of available queues at the network node based on the information identifying the number of retransmissions to be performed for delivery of one or more packets from the network node to the TSN node and transmitting the one or more packets from the set of available queues in accordance with the predetermined scheme/cyclic order. The PDC mechanism may be implemented by the network node to reduce PDV.

A probability distribution of delivery of a packet with #ReT number of retransmissions to be performed for delivery of the packet is depicted in FIG. 7A. The network node may implement the PDC mechanism based on the information identifying the number of retransmissions to be performed for delivery of the packet to increase the lower bound of the packet delay towards the upper bound of the packet delay in the #ReT number of retransmissions (dotted lines), as depicted in FIG. 7B. Thus, reducing the PDV.

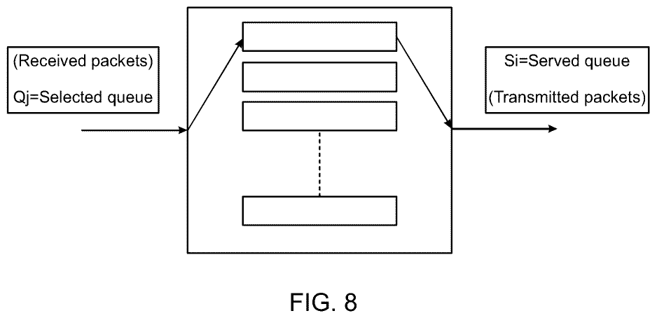

FIG. 8 discloses an example illustration of the PDC mechanism based on selection of a queue from a set of available queues at the network node. In some embodiments, the network node may achieve the PDC by utilizing information identifying the number of retransmissions to be performed for delivery of the one or more packets, so that PDV may be decreased. For example, the PDC may involve a proper selection of the queue for the packet based on the information identifying the number of retransmissions to be performed for delivery of the packet and transmission of the packet from the set of queues in the cyclic order. Thus, utilizing Cyclic Queuing and Forwarding, COF, for transmission of the packet, which reduces the PDV. As depicted in FIG. 8, to achieve the PDC mechanism,
the network node receives the packet over the air after a number of re-transmissions (#ReT={0, 1, 2, . . . });
the network node selects a queue (‘j’) for the packet based on the information identifying the number of retransmissions to be performed for delivery of the packet from the network node to the TSN node. For example, the queue (‘j’) may be represented as:

$$j = i + ( N - \# ReT )$$

wherein ‘N’ indicates the number of available queues at the network node and ‘i’ indicates an actually served queue (i.e., the queue being currently utilized). In some embodiments, the network node may select the queue for the packet based on the number of available queues, the queue currently being served and the number of retransmissions associated with each packet. It should be noted the queue may be selected for the packet in accordance with multiple methods including the above described method;
upon selection of the queue for the packet, the network node transmits the packet from the set of queues in the cyclic order. Thus, reducing the PDV. For example, serving time of the queue available at the network node may equal to time required for the retransmission of the packets over the air interface (i.e., a retransmission cycle). For instance, the service/serving time of queue may be represented as:

$${T}_{CQF - service time per queue} = {T}_{retransmission}$$

Therefore, the resulted packet delay may be bounded and may be in a range of packet delay, PD: {(N−1)×Tᵣₑₜᵣₐₙₛₘᵢₛₛᵢₒₙ; N×Tᵣₑₜᵣₐₙₛₘᵢₛₛᵢₒₙ}, so that the PDV may also be bounded as PDV=Tᵣₑₜᵣₐₙₛₘᵢₛₛᵢₒₙ. In addition, the PDV may be significantly lower that Tᵣₑₜᵣₐₙₛₘᵢₛₛᵢₒₙ, depending upon a service rate of cyclic queueing and forwarding of the packet from the queue (i.e., CQF service rate) and a traffic situation.

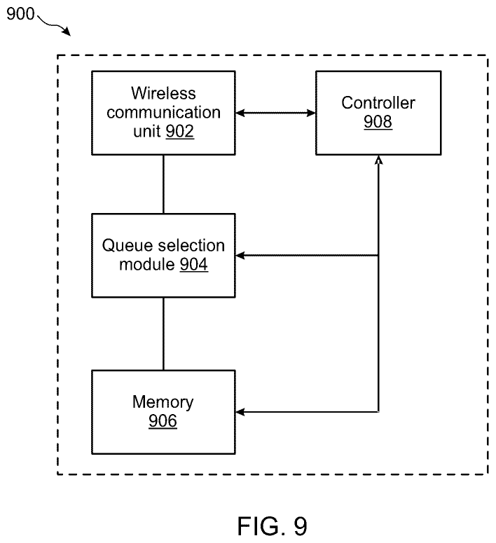

FIG. 9 is an example schematic diagram showing an apparatus 900. The apparatus 900 may e.g. be comprised in the network node. The network node is capable of handling transmission of one or more packets based on information identifying a number of retransmissions to be performed for delivery of the one or more packets and may be configured to cause performance of the method 500 for handling transmission of the one or more packets based on the information identifying the number of retransmissions to be performed for delivery of the one or more packets.

According to at least some embodiments of the present invention, the apparatus 900 in FIG. 9 comprises one or more modules. These modules may e.g. be a wireless communication unit 902, a queue selection module 904, a memory 906, and a controller 908. The controller 908, may in some embodiments be adapted to control the above mentioned modules.

The wireless communication unit 902, the queue selection module 904, the memory 906, as well as the controller 908, may be operatively connected to each other.

The controller 908 may be adapted to control the steps as executed by the network node. For example, the controller 908 may be adapted for handling transmission of one or more packets based on information identifying a number of retransmissions to be performed for delivery of the one or more packets (as described above in conjunction with the method 500 and FIG. 5).

The queue selection module 904 may be adapted to select the queue for each packet of the one or more packets for transmission. The queue selection module 904 may select the queue from the set of available queues at the network node based on the information identifying the number of retransmissions to be performed for delivery of the one or more packets from the network node to the TSN node.

The wireless communication unit 902 may be adapted to transmit the one or more packets (for example, to the TSN node) from the set of available queues in the cyclic order, wherein each packet may be assigned with the queue from the set of available queues.

The memory 906 may store at least one of: the information identifying the number of retransmissions to be performed for delivery of the one or more packets, information about set of available queues at the network node, and so on.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include digital signal processors, DSPs, special-purpose digital logic, and the like. The processing circuitry may be configured to execute program code stored in memory, which may include one or several types of memory such as read-only memory (ROM), random-access memory, RAM, cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the disclosure.

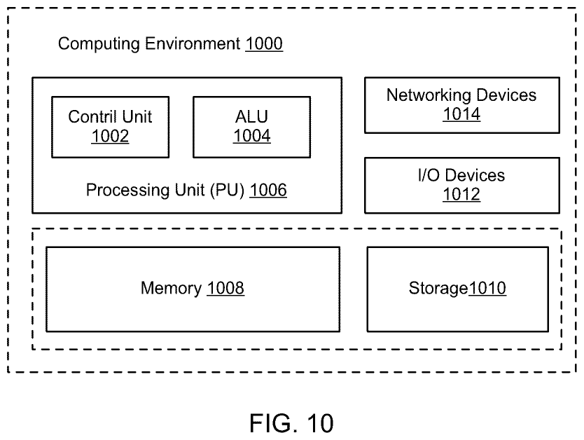

FIG. 10 illustrates an example computing environment 1000 implementing a method and the apparatus, as described in FIGS. 5 and 9. As depicted in FIG. 10, the computing environment 1000 comprises at least one data processing module 1006 that is equipped with a control module 1002 and an Arithmetic Logic Unit (ALU) 1004, a plurality of networking devices 1014 and a plurality Input output, I/O devices 1012, a memory 1008, a storage 1010. The data processing module 1006 may be responsible for implementing the method described in FIG. 5. For example, the data processing module 1006 may in some embodiments be equivalent to the CPU/processor/controller of the apparatus described above in conjunction with the FIG. 9. The data processing module 1006 is capable of executing software instructions stored in memory 1008. The data processing module 1006 receives commands from the control module 1002 in order to perform its processing. Further, any logical and arithmetic operations involved in the execution of the instructions are computed with the help of the ALU 1004.

The computer program is loadable into the data processing module 1006, which may, for example, be comprised in an electronic apparatus (such as a network node). When loaded into the data processing module 1006, the computer program may be stored in the memory 1008 associated with or comprised in the data processing module 1006. According to some embodiments, the computer program may, when loaded into and run by the data processing module 1006, cause execution of method steps according to, for example, any of the method illustrated in FIG. 5 or otherwise described herein.

The overall computing environment 1000 may be composed of multiple homogeneous and/or heterogeneous cores, multiple CPUs of different kinds, special media and other accelerators. Further, the plurality of data processing modules 1006 may be located on a single chip or over multiple chips.

The algorithm comprising of instructions and codes required for the implementation are stored in either the memory 1008 or the storage 1010 or both. At the time of execution, the instructions may be fetched from the corresponding memory 1008 and/or storage 1010, and executed by the data processing module 1006.

In case of any hardware implementations various networking devices 1014 or external I/O devices 1012 may be connected to the computing environment to support the implementation through the networking devices 1014 and the I/O devices 1012.

The embodiments disclosed herein can be implemented through at least one software program running on at least one hardware device and performing network management functions to control the elements. The elements shown in FIG. 10 include blocks which can be at least one of a hardware device, or a combination of hardware device and software module.

1. A method performed by a network node of a wireless communication network, the wireless communication network operating as a virtual Time-Sensitive Networking, TSN, bridge of a TSN system, the method comprising:
obtaining information identifying a number of retransmissions to be performed for delivery of one or more packets from the network node to a TSN node;
selecting a queue for each packet, from a set of available queues at the network node based on the information identifying the number of retransmissions; and
transmitting the one or more packets from the set of available queues according to a predetermined scheme.

2. The method according to claim 1, wherein the step of obtaining the information identifying the number of retransmissions to be performed for delivery of the one or more packets comprises:
estimating the number of retransmissions to be performed for delivery of the one or more packets based on one or more of: information received from a scheduler of the network node, a number of retransmissions performed by a transmitter of the network node and a number of retransmissions required to be performed for decoding the packet at a receiver of the network node.

3. The method according to claim 1, wherein the step of selecting the queue for each packet, from the set of available queues at the network node based on the information identifying the number of retransmissions comprises:
determining a number of available queues at the network node and a queue that is currently being served for transmission of packets from the network node; and
selecting the queue for transmitting each packet based on the number of available queues, the queue currently being served and the number of retransmissions associated with each packet.

4. The method according to claim 1, wherein the step of transmitting the one or more packets from the selected queue comprises:
selecting the queue for transmission of the one or more packets from the set of available queues at the network node in a cyclic order; and
transmitting each packet from the selected queue,
wherein each packet is allowed to be stored in a selected queue for a pre-determined time interval.

5. An apparatus of a network node of a wireless communication network, the wireless communication network operating as a virtual Time-Sensitive Networking, TSN, bridge of a TSN system, the apparatus is being configured to cause:
obtaining of information identifying a number of retransmissions to be performed for delivery of one or more packets from the network node to a TSN node;
selection of a queue for each packet, from a set of available queues at the network node based on the information identifying the number of retransmissions; and
transmission of the one or more packets from the set of available queues according to a predetermined scheme.

6. The apparatus according to claim 5, wherein the apparatus is configured to cause obtaining of the information identifying the number of retransmissions to be performed for delivery of the one or more packets by causing:
estimation of the number of retransmissions to be performed for delivery of the one or more packets based on one or more of: information received from a scheduler of the network node, a number of retransmissions performed by a transmitter of the network node and a number of retransmissions required to be performed for decoding the packet at a receiver of the network node.

7. The apparatus according to claim 5, wherein the apparatus is configured to cause selection of the queue for each packet, from the set of available queues at the network node based on the information identifying he number of retransmissions by causing:
determination of a number of available queues at the network node and a queue that is currently being served for transmission of packets from the network node; and
selection of the queue for transmitting each packet based on the number of available queues, the queue currently being served and the number of retransmissions associated with each packet.

8. The apparatus according to claim 5, wherein the apparatus is configured to cause transmission of the one or more packets from the selected queue by causing:
selection of the queue for transmission of the one or more packets from the set of available queues at the network node in a cyclic order; and
transmission of each packet from the selected queue,
wherein each packet is allowed to be stored in a selected queue for a pre-determined time interval.

9. A network node of a wireless communication network, the wireless communication network operating as a virtual Time-Sensitive Networking, TSN, bridge of a TSN system, the network node comprising an apparatus of configured to cause:
obtaining of information identifying a number of retransmissions to be performed for delivery of one or more packets from the network node to a TSN node;
selection of a queue for each packet, from a set of available queues at the network node based on the information identifying the number of retransmissions; and
transmission of the one or more packets from the set of available queues according to a predetermined scheme.

10. A non-transitory computer readable medium, having thereon a computer program comprising program instructions, wherein the computer program is loadable into a data processing unit and configured to cause execution of the method according to claim 1 when the computer program is run by the data processing unit.
